(19) United States
(12) Patent Application Publication
(10) Pub. No.: US 2019/0163905 A1
(43) Pub. Date: May 30, 2019

(54) System, Method, and Apparatus for Preventing Execution of Malicious Scripts

(71) Applicant: PC Pitstop, Inc., SIOUX CITY, IA (US)

(72) Inventor: Robert J. Woodworth, Charleston, SC (US)

(73) Assignee: PC Pitstop, Inc., SIOUX CITY, IA (US)

(21) Appl. No.: 16/201,185

(22) Filed: Nov. 27, 2018

Related U.S. Application Data
(60) Provisional application No. 62/590,927, filed on Nov. 27, 2017.

(51) Int. Cl. G06F 21/56; G06F 21/55

(52) U.S. Cl. CPC G06F 21/562; G06F 2221/033; G06F 21/554

(57) ABSTRACT

A method of preventing execution of malicious scripts includes intercepting a script that originates from an application program running on a computer before directing the script to a script engine and determining the origin of the script (e.g. the script is from a web site, from a temporary file, from a registry key, or from an environment variable). Next, it is determined whether the script is malicious by analyzing the origin of the script and if the script originated from a web site of a foreign country, an environmental variable, a registry key, or a temporary folder, the script is determined to be malicious. If the script is malicious, execution of the script is suppressed or if the script is not malicious, the script is forwarded to the script engine and executed by the script engine.

### CROSS-REFERENCE TO RELATED APPLICATION

This application claims the benefit of U.S. provisional application No. 62/590,927 filed on Nov. 27, 2017, the disclosure of which is incorporated by reference.

### FIELD

This invention relates to the field of computer security and more particularly to a system for reducing attacks by malicious scripts.

### BACKGROUND

Currently, many software systems attempt to provide a secure computing environment. Such software systems are typically referred to as firewalls, anti-malware software, etc. Any computer (including cellular phones) that is connected to a network is subject to intrusion via that network. One area of vulnerability is attacks from malicious scripts, for example, infecting computers that run Microsoft Windows as their operating system. These scripts typically use built-in functionality within the operating system to start an attack on the computer. If the script is successfully executed by the operating system, malware can be delivered to the victim's computer.

Such infections scripts are often called fileless infection or fileless ransomware, as there is no file/executable that is stored on the target computer system. Users typically contract a fileless infection by visiting a malicious website. Often, the malware doesn't infect the user's computer, instead issuing obnoxious warnings (called maladvertising) that look official, telling the user that their computer is infected that there is a grave danger and that the user must immediately call a phone number that will ring a phone of the company that inserted the fileless infection where the user will be pressured to pay money to rectify the situation. In some cases, during the phone call, the company that inserted the fileless infection instructs the user to install other software that itself contains more harmful viruses that are capable of damage and/or stealing private data.

It is difficult for virus scanners and firewalls to prevent fileless infections because there is no file involved, so these virus scanners can't analyze a file stored in a file system to make sure it has the correct attributes (e.g. file name, size, hash value, checksum, signature).

One class of fileless infections is delivered in scripts such as Javascripts. When the user visits a website containing the malware and clicks on a feature, the infectious Javascript is streamed to the user's computer where it executes in a browser and, subsequently, performs whatever malicious task that the fileless infection is programmed to perform, such as maladvertising, as described above.

Most fileless infections disappear from the infected computer after performing their intended task (e.g. maladvertisement) or sometimes after a reboot, but some fileless infections stay resident even after a reboot. There are many known fileless infections such as Powerliks, Kovter, PowerSniff, USB Thief, and PhaseBot.

What is needed is a system that will prevent the execution of malicious scripts.

### SUMMARY

In one embodiment, a system for preventing execution of malicious scripts is disclosed including a computer having there installed an operating system. A script checking engine is installed in the operating system, the script engine comprising software. The software receives a script for execution by the operating system, the software determines if the script is malicious, and if the software determines that the script is not malicious, the software passes the script to the script engine of the operating system.

In another embodiment, system for preventing execution of malicious scripts is disclosed, including a computer having there installed an operating system. A script checking engine is installed in the operating system. The script checking engine intercepts scripts that originate from application programs and are directed to be run by a script engine. The script checking engine receives the scripts before execution by the script engine and determines if the scripts are malicious. If the script checking engine determines that the scripts are not malicious, the script checking engine passes the script to the script engine.

In another embodiment, a method of preventing execution of malicious scripts is disclosed including intercepting a script that originates from an application program running on a computer before directing the script to a script engine and determining if the script is malicious. If the script is not malicious, the script is passed to the script engine or if the script is malicious, an attempt to execute a malicious script is logged and a user of the computer is informed about the attempt to execute the malicious script.

In another embodiment, a method of preventing execution of malicious scripts is disclosed including intercepting a script that originates from an application program running on a computer before directing the script to a script engine and determining the origin of the script (e.g. the script is from a web site, from a temporary file, from a registry key, or from an environment variable). Next, it is determined whether the script is malicious by analyzing the origin of the script and if the script originated from a web site of a foreign country, an environmental variable, a registry key, or a temporary folder, the script is determined to be malicious. If the script is malicious, execution of the script is suppressed or if the script is not malicious, the script is forwarded to the script engine and executed by the script engine.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a data connection diagram of the computer security system.

FIG. 2 illustrates a schematic view of a typical computer protected by the computer security system.

FIG. 3 illustrates a schematic view of a typical server computer system.

FIG. 4 illustrates a script interface to an exemplary operating system.

FIG. 5 illustrates an exemplary flow of the computer security system.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

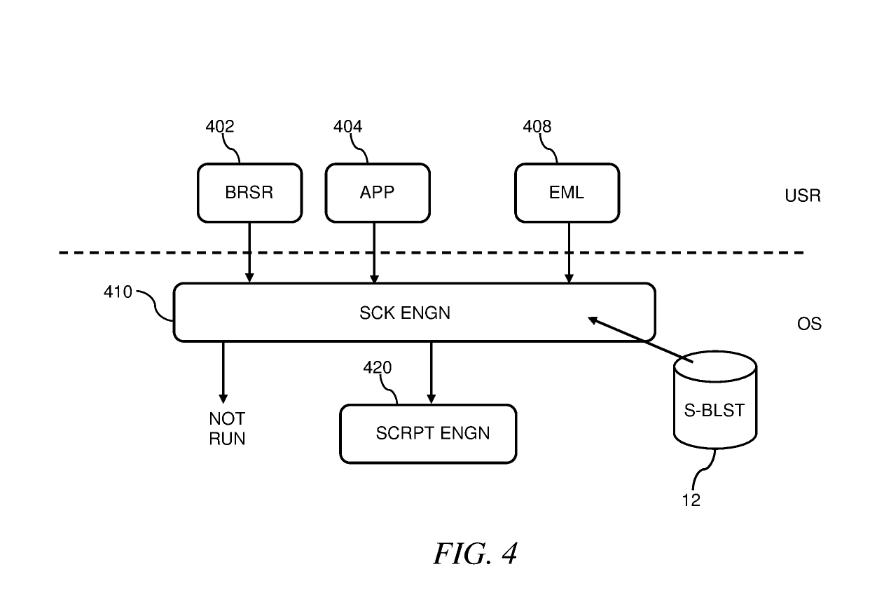

In general, the system for preventing execution of malicious scripts is installed to intercept all scripts before the script is executed by a scripting engine 420 (see FIG. 4). For example, in an exemplary Windows-based operating system, a Power Shell script comes from a program running at the user level, for example, from a browser, an email program, or from another application. Prior to the system for preventing execution of malicious scripts, the scripting engine 420 blindly executed the script. This is the way many malicious programs are loaded onto computer systems, especially those that are delivered in email messages (through email programs) or from web sites (through browsers). The system for preventing execution of malicious scripts inserts a script checking engine 410 (see FIG. 4) between the user level applications and the scripting engine 420. As will be shown, the script checking engine 410 performs several checks to verify that the script is not malicious before the script checking engine 410 passes the script to the scripting engine 420 for execution.

Throughout this description, the term, “computer” refers to any system that has a processor and runs software. One example of such is a personal computer. Another example is a smartphone or tablet. The term, “user” refers to a human that has an interest in the computer, perhaps a user who interacts with the computer.

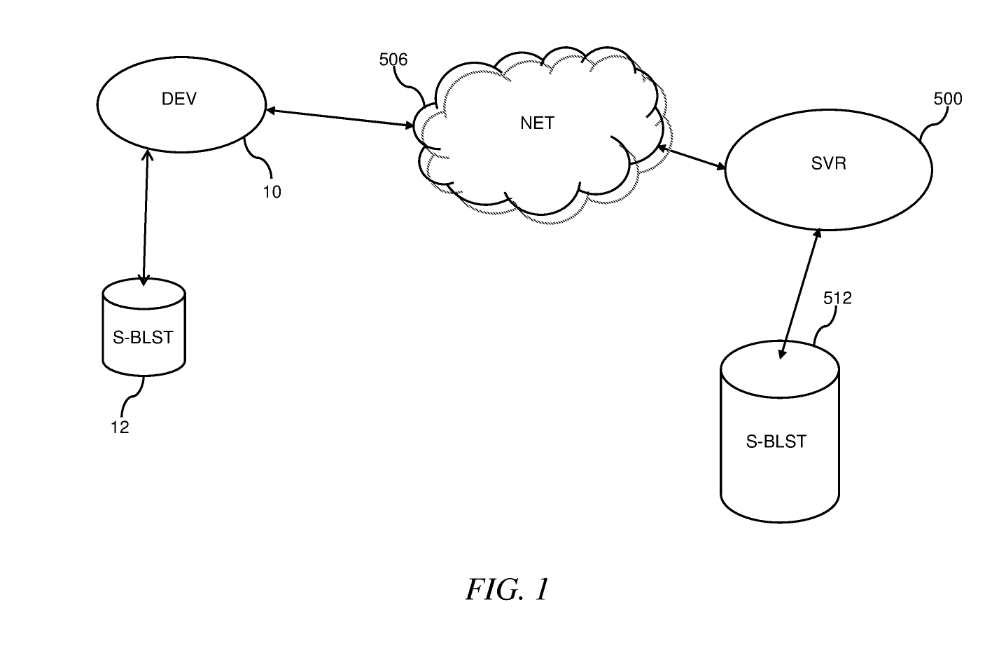

Referring to FIG. 1, a data connection diagram of the exemplary system for preventing execution of malicious scripts is shown. In this example, a computer 10 (e.g., personal computer) communicates through a network 506 (e.g. the Internet, local area network, etc.) to a server computer 500.

The server computer 500 has access to data storage for maintaining one or more script blacklists 512. In some embodiments, the data storage is in the cloud. In some embodiments, the script blacklists 512 are cached in storage of the computer 10 being protected (local script blacklists 12).

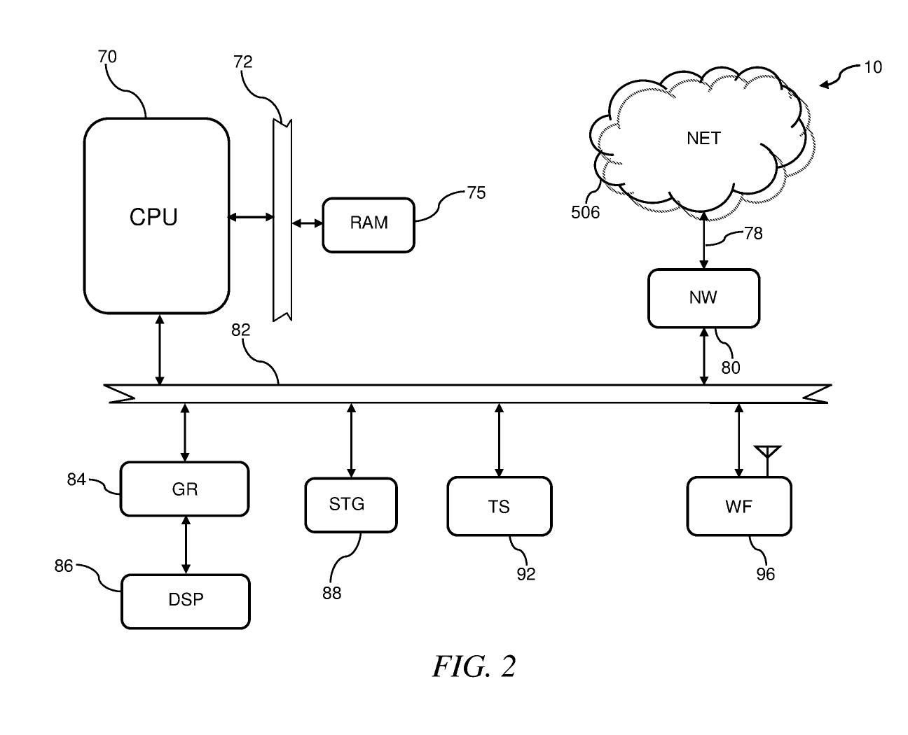

Although one path between the computer 10 and the server 500 is shown going through the network 506, any known data path is anticipated. For example, the Wi-Fi transceiver 96 (see FIG. 2) of the computer 10 is used to communicate with the wide area network 506, which includes the Internet, and, consequently, with the server computer 500.

The computer 10 transacts with software running on the server computer 500 through the network(s) 506 to periodically update the local script blacklist 12 from the server's 500 script blacklist 512.

The system for preventing execution of malicious scripts selectively provides execution approval of scripts that attempt to execute on the computer 10. In such, if approval is provided by the script checking engine 410, the script is passed to the scripting engine 420 for execution on the computer 10. If approval is not provided, the script is blocked from executing on the computer 10 and various additional steps are taken such as logging the attempt, transferring the suspect script to the server 500 for analysis, informing the user of the computer 10, etc.

In one embodiment, the script checking engine 410 analyze how the invocation is coming into the scripting engine 420. Heuristics determine when calls to the scripting engine 420 are inappropriate. For example, when the script that is being forwarded to the scripting engine 420 emanates from an environment variable or a registry key, the script checking engine 410 flags that script as malicious. Another example is the running of PowerShell straight from a foreign web site (a web site located in a different country).

Referring to FIG. 2, a schematic view of a typical computer 10 that is protected by the system for preventing execution of malicious scripts is shown. The present invention is in no way limited to a computer 10, known as a personal computer. Many other processor-based devices are equally anticipated including, but not limited to smart phones, cellular phones, portable digital assistants, routers, thermostats, fitness devices, etc.

The example computer 10 represents a typical device used for accessing user interfaces of the computer security system. This exemplary computer 10 is shown in its simplest form. Different architectures are known that accomplish similar results in a similar fashion, and the present invention is not limited in any way to any particular computer 10 system architecture or implementation. In this exemplary computer 10, a processor 70 executes or runs programs in a random-access memory 75. The programs are generally stored within a persistent storage 88 and loaded into the random-access memory 75 when needed. In some computers 10, the persistent storage 88 (e.g., compact flash, SD) offers removable persistent storage. The processor 70 is any processor, typically a processor designed for phones. The random-access memory 75 is connected to the processor by, for example, a memory bus 72. The random-access memory 75 is any memory suitable for connection and operation with the selected processor 70, such as SRAM, DRAM, SDRAM, RDRAM, DDR, DDR-2, etc.

Also connected to the processor 70 is a system bus 82 for connecting to peripheral subsystems such as a network interface 80, a graphics adapter 84, persistent storage 88, and a touch screen interface 92. The graphics adapter 84 receives commands from the processor 70 and controls what is depicted on the display 86. The touch screen interface 92 provides navigation and selection features.

Persistent storage 88 is any type, configuration, capacity of memory suitable for persistently storing data, for example, flash memory, read only memory, battery-backed memory, hard disk, etc. In some exemplary computer 10, the persistent storage 88 is removable, in the form of a memory card of appropriate format such as SD (secure digital) cards, micro SD cards, compact flash, etc.

In general, some portion of the persistent memory 88 is used to store programs, executable code, phone numbers, contacts, and data, etc. In some embodiments, other data is stored in the persistent memory 88 such as audio files, video files, text messages, etc.

The peripherals are examples, and other devices are known in the industry such as Global Positioning Subsystems, speakers, microphones, USB interfaces, cameras, microphones, Bluetooth transceivers, Wi-Fi transceivers 96, image sensors, temperature sensors, etc., the details of which are not shown for brevity and clarity reasons.

The network interface 80 connects the computer 10 to the network 506 through any known or future protocol such as Ethernet, Wi-Fi, GSM, TDMA, LTE, etc., through a wired or wireless medium 78. There is no limitation on the type of connection used. The network interface 80 provides data and messaging connections between the computer 10 and the server 500 through the network 506.

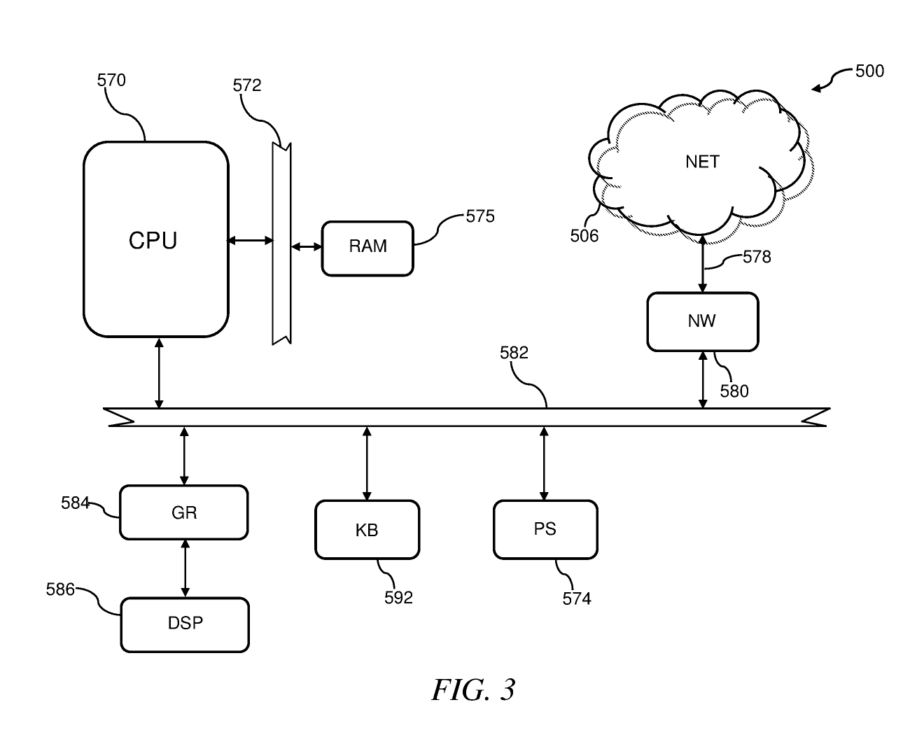

Referring to FIG. 3, a schematic view of a typical server computer system (e.g., server 500) is shown. The example server computer system 500 represents a typical server computer system used for back-end processing, generating reports, displaying data, etc. This exemplary server computer system 500 is shown in its simplest form. Different architectures are known that accomplish similar results in a similar fashion and the present invention is not limited in any way to any particular computer system architecture or implementation. In this exemplary computer system, a processor 570 executes or runs programs in a random-access memory 575. The programs are generally stored within a persistent memory 574 and loaded into the random-access memory 575 when needed. The processor 570 is any processor, typically a processor designed for computer systems with any number of core processing elements, etc. The random-access memory 575 is connected to the processor by, for example, a memory bus 572. The random-access memory 575 is any memory suitable for connection and operation with the selected processor 570, such as SRAM, DRAM, SDRAM, RDRAM, DDR, DDR-2, etc. The persistent memory 574 is any type, configuration, capacity of memory suitable for persistently storing data, for example, magnetic storage, flash memory, read only memory, battery-backed memory, magnetic memory, etc. The persistent memory 574 is typically interfaced to the processor 570 through a system bus 582, or any other interface as known in the industry.

Also shown connected to the processor 570 through the system bus 582 is a network interface 580 (e.g., for connecting to a data network 506), a graphics adapter 584 and a keyboard interface 592 (e.g., Universal Serial Bus—USB). The graphics adapter 584 receives commands from the processor 570 and controls what is depicted on a display 586. The keyboard interface 592 provides navigation, data entry, and selection features.

In general, some portion of the persistent memory 574 is used to store programs, executable code, and other data, etc.

The peripherals are examples and other devices are known in the industry such as pointing devices, touch-screen interfaces, speakers, microphones, USB interfaces, Bluetooth transceivers, Wi-Fi transceivers, image sensors, temperature sensors, etc., the details of which are not shown for brevity and clarity reasons.

Referring to FIG. 4, an exemplary program connection diagram of the system for preventing execution of malicious scripts is shown. In this, three user-level applications 402/404/408 are shown. Such applications run in the user-level and have limited ability to modify the computer 10 on which they run. In the past, when, for example, a browser 402, an application 404, or an email program 408 requested execution of a script, the script was passed directly into the scripting engine 420 (e.g. powershell, wscript, cscript) and was executed by a scripting engine 420. As the scripting engine 420 operates in the protected mode of the operating system, it was possible to create malicious scripts that, once executed in the protected mode, the scripts perform malicious acts such as loading malicious software onto the computer 10 or displaying maladvertisements.

In FIG. 4, an additional layer called the script checking engine 410 is inserted between the user-level applications 402/404/408 and the scripting engine 420. The script checking engine 410 determines if a script is good or bad based on the parameters passed from the user-level applications 402/404/408. For example, if the script is a PowerShell script and it tries to elevate privileges, the script checking engine 410 recognizes such and prevents execution of that script. The script checking engine 410 has “rules” that are updated on a regular basis by downloads from the server, improving the ability to detect malicious scripts.

The script checking engine 410 also uses the parent process as a “weighting” mechanism, to determine the malicious level. For example, if a script is launched from an email program 408, the script is likely malicious, being that hackers often spread malicious scripts via email and scripts are not typically run from email.

The script checking engine 410 also looks at the directory or location from where the script is being launched. For example, if the script is launched from a user file, it likely isn't malicious. However, if the script is launched from the % temp % (temporary files stored in a temporary file folder), then the script likely came from a browser 402 or from an application 404, and that script is blocked as malicious scripts typically find a home in temporary files. If the script came from an environmental variable, it is also likely malicious. If the script is stored in a registry key, it is also likely malicious.

If the script emanated from an environment variable or a registry key, the script checking engine 410 determines that script is likely malicious. Likewise, if a script is to be executed by PowerShell and that script originated from a foreign web site (a web site located in a different country), that script is likely malicious.

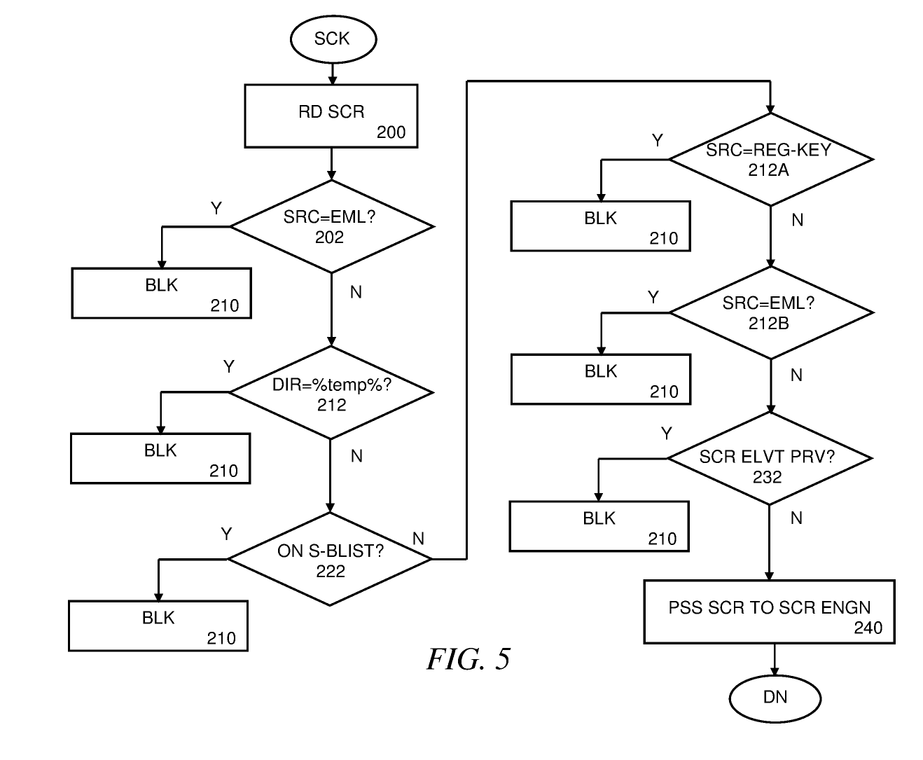

Referring to FIG. 5, an exemplary program flow of the system for preventing execution of malicious scripts is shown. The flow starts when the script checking engine 410 receives a script from a user-level application 402/404/408. Such applications run in the user-level and have limited ability to modify the computer 10 on which they run. The operating system runs at a higher security level (e.g. kernel level) and, therefore, has the ability to modify just about every data and operation of the computer 10. The script checking engine 410 and the scripting engine 420 operate in the protected mode of the operating system of the computer 10.

The script checking engine 410 is inserted between the user-level applications 402/404/408 and the scripting engine 420. The script checking engine 410 reads the script 200 and determines 202 if the script is launched from an email program 408. If the script is launched from an email program 408 the script is likely malicious, being that hackers spread malicious scripts via email, and the script is blocked 210.

The script checking engine 410 checks 212 the directory or location from where the script is being launched. If the script checking engine 410 checks 212 the directory and finds that the script was launched from a safe location (e.g. the Desktop), it likely isn't malicious and the process continues. However, if the script checking engine 410 checks 212 the directory and finds that the script was launched from an unsafe location (e.g. the from % temp %, temporary files folder), then the script likely came from a browser 402 or from an application 404, and that script is blocked 210 as malicious scripts typically are stored in temporary files.

Next, in some embodiments, the script and environment that the script is run in (e.g. parent process, command-line parameters) is analyzed. The analysis 222 algorithmically/heuristically looks for phrases in the scripts that match known malware. If the analysis 222 determines that the script contains malware, it is blocked. Otherwise the process continues.

The script checking engine 410 checks 212A the origin of the script to determine if the script originated from a registry key. If the script checking engine 410 finds that the script did not originate from a registry key (e.g. the Desktop), the process continues. However, if the script checking engine 410 finds that the script did originate from a registry key, then the script is blocked 210 as malicious scripts typically are stored in registry keys.

The script checking engine 410 checks 212B the origin of the script to determine if the script originated from an environmental variable. If the script checking engine 410 finds that the script did not originate from an environmental variable (e.g. the Desktop), the process continues. However, if the script checking engine 410 finds that the script did originate from an environmental variable, then the script is blocked 210 as malicious scripts typically are stored in registry keys.

If the script is a PowerShell script and it tries to elevate privileges 232, the script checking engine 410 recognizes such and blocks execution of that script.

If all of the above tests pass, then the script is deemed to not be malicious and the script is passed 240 to the scripting engine 420.

The script checking engine 410 has “rules” that are updated on a regular basis by downloads from the server, improving the ability to detect malicious scripts. The exemplary program flow is anticipated to execute on a user device such as a computer 10. For brevity, local script blacklists 12 update procedures and heuristic update procedures are not shown.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for preventing execution of malicious scripts, the system comprising:
a computer having there installed an operating system;
a script checking engine installed in the operating system, the script checking engine intercepts scripts that originate from application programs and are directed to be run by a script engine;
the script checking engine receives the scripts and execution environment before execution by the script engine, the script checking engine determines if the scripts are malicious, and if the script checking engine determines that the scripts are not malicious, the script checking engine passes the script to the script engine.

2. The system for preventing execution of malicious scripts of claim 1, wherein the script checking engine determines if the scripts are malicious based upon an origin of the script.

3. The system for preventing execution of malicious scripts of claim 2, wherein the script checking engine determines that the script is malicious if the origin of the script is a website located in a foreign country.

4. The system for preventing execution of malicious scripts of claim 2, wherein the script checking engine determines that the script is malicious if the origin of the script is from a temporary folder, the temporary folder in a storage operatively coupled to the computer.

5. The system for preventing execution of malicious scripts of claim 2, wherein the script checking engine determines that the script is malicious if the origin of the script is a website located in a foreign country.

6. The system for preventing execution of malicious scripts of claim 2, wherein the script checking engine determines that the script is malicious if the origin of the script is from an environment variable, the environment variable being from a run-time environment of the computer.

7. The system for preventing execution of malicious scripts of claim 2, wherein the script checking engine determines that the script is malicious if the origin of the script is from a registry key, the registry key being from a registry of the computer.

8. A method of preventing execution of malicious scripts, the method comprising:
intercepting a script that originate from an application program running on a computer before directing the script to a script engine;
determining if the script is malicious, and if the script is not malicious, passing the script to the script engine; and
if the script is malicious, logging an attempt to execute a malicious script and informing about the attempt to execute the malicious script.

9. The method of claim 8, wherein the step of determining if the script is malicious includes determining an origin of the script.

10. The method of claim 9, wherein the step of determining if the script is malicious includes determining if the origin of the script is a website located in a foreign country and if the origin of the script is a website located in the foreign country, the script is flagged as malicious.

11. The method of claim 9, wherein the step of determining if the script is malicious includes determining if the origin of the script is from a temporary folder, the temporary folder in a storage operatively coupled to the computer, and if the origin of the script is the temporary folder, the script is flagged as malicious.

12. The method of claim 9, wherein the step of determining if the script is malicious includes determining if the origin of the script is from a temporary folder, the temporary folder in a storage operatively coupled to the computer, and if the origin of the script is the temporary folder, the script is flagged as malicious wherein the script checking engine determines that the script is malicious if the origin of the script is a website located in a foreign country.

13. The method of claim 9, wherein the step of determining if the script is malicious includes determining if the origin of the script is from an environment variable, the environment variable being from a run-time environment of the computer, and if the origin of the script is the environment variable, the script is flagged as malicious.

14. The method of claim 9, wherein the step of determining if the script is malicious includes determining if the origin of the script is from a registry key, the registry key being from a registry of the computer, and if the origin of the script is the registry key, the script is flagged as malicious.

15. A method of preventing execution of malicious scripts, the method comprising:
intercepting a script that originate from an application program running on a computer before directing the script to a script engine;
determining an origin of the script;
determining if the script is malicious by analyzing the origin of the script and if the script originated from the group consisting of a web site of a foreign country, an environmental variable, a registry key, and a temporary folder, the script is malicious;
if the script is malicious, suppressing execution of the script; and
if the script is not malicious, forwarding the script to the script engine and executing the script.

16. The method of claim 15, wherein the step of suppressing execution of the script further includes a step of transferring the script that has been found to be malicious to a server for further analysis.

17. The method of claim 15, wherein the step of suppressing execution of the script further includes a step of logging information regarding the script that has been found to be malicious.

18. The method of claim 15, wherein the step of suppressing execution of the script further includes a step of informing a user of the computer that the script has been found to be malicious.
